(19) United States
(12) Patent Application Publication
(10) Pub. No.: US 2022/0229321 A1
(43) Pub. Date: Jul. 21, 2022

(54) DISPLAY PANEL AND METHOD OF MANUFACTURING SAME

(71) Applicant: Shenzhen China Star Optoelectronics Semiconductor Display Technology Co., Ltd., Shenzhen (CN)

(72) Inventors: Nian ZHAO, Shenzhen (CN); Qingyong ZHU, Shenzhen (CN)

(21) Appl. No.: 16/620,924

(22) PCT Filed: Nov. 5, 2019
(86) PCT No.: PCT/CN2019/115577

§ 371 Date: Dec. 10, 2019

(30) Foreign Application Priority Data
Oct. 12, 2019 (CN) 201910966006.7

(51) Int. Cl. G02F 1/1339; G02F 1/1368; G02F 1/1335; G02F 1/1362; G02F 1/1333

(52) U.S. Cl. CPC G02F 1/1339; G02F 1/1368; G02F 1/133516; G02F 2201/50; G02F 1/133512; G02F 1/133357; G02F 1/136227

(57) ABSTRACT

A display panel and a method of manufacturing of the same are provided. The display panel includes a first transparent substrate and a second transparent substrate disposed opposite to each other. A planarization protective layer is disposed between the first transparent substrate and the second transparent substrate. The planarization protective layer is provided with a hollow portion in a sealant area. A sealant is disposed in the sealant area and disposed between the first transparent substrate and the second transparent substrate. The sealant extends into the hollow portion to cause the first transparent substrate and the second transparent substrate to be fixed through the sealant.

### FIELD OF INVENTION

The present disclosure relates to the field of display panel technologies, and more particularly to a display panel and a method of manufacturing the same.

### BACKGROUND OF INVENTION

In existing color filter on array (COA) type panels, a planarization protective layer having a transparent organic material is covered on a R/G/B color resist by a polymer film on array (PFA) process to replace an original inorganic material (SiNx). This not only saves steps of chemical vapor deposition (CVD) and stripping in processes, but also flattens terrain of the R/G/B color resist and improves process coating properties. In addition, the role of a sealant in the panel is to combine upper and lower two glass substrates (i.e., a first transparent substrate and a second transparent substrate) in a cell by its adhesiveness. This protects liquid crystal from contact with external moisture and impurities, preventing the liquid crystal from flowing out and supporting a gap between edges of the panel.

In the prior art, a panel structure using a PFA has a small gap between the first transparent substrate and the second transparent substrate in the panel due to arrangement of the planarization protective layer. However, a cross-sectional area of the existing manufacturing process for the sealant is fixed, and the smaller the gap, the wider the width of the sealant, so that the panel cannot meet demand for a narrow frame. There is an urgent need for a structure and method for improving a width of a sealant in a panel structure to meet requirements of a narrow frame.

### SUMMARY OF INVENTION

An embodiment of the present invention provides a display panel and a method of manufacturing the same, so as to solve issues that a gap of a sealant coating is shortened due to arrangement of a planarization protective layer in a panel coating area and this causes a sealant width to not meet the narrow frame requirements.

An embodiment of the present application provides a display panel, comprising: a sealant area; a first transparent substrate and a second transparent substrate disposed opposite to each other; a planarization protective layer disposed between the first transparent substrate and the second transparent substrate, wherein the planarization protective layer is provided with a hollow portion in the sealant area; and a sealant disposed in the sealant area and disposed between the first transparent substrate and the second transparent substrate, wherein the sealant extends into the hollow portion to cause the first transparent substrate and the second transparent substrate to be fixed through the sealant.

In an embodiment of the present application, a side of the first transparent substrate adjacent to the second transparent substrate is provided with a thin film transistor (TFT) layer, and a side of the TFT layer adjacent to the second transparent substrate is provided with a passivation protective layer, the planarization protective layer is disposed on the passivation protective layer, and the sealant is disposed between the passivation protective layer and the second transparent substrate.

In an embodiment of the present application, the display panel further comprises a color resist layer, a conductive layer, and a liquid crystal layer disposed in an inner area of the sealant, wherein the color resist layer is disposed on the passivation protective layer, the planarization protective layer is disposed on the color resist layer and the passivation protective layer and covers the color resist layer, the conductive layer is disposed on the planarization protective layer, and the liquid crystal layer is disposed on the conductive layer.

In an embodiment of the present application, the conductive layer comprises a pixel electrode, a drain of the TFT layer is provided with a via hole sequentially passing through the passivation protective layer, the color resist layer, and the planarization protective layer, and the pixel electrode is electrically connected to the drain through the via hole.

In an embodiment of the present application, the via hole comprises a first via hole disposed on the passivation protective layer, a second via hole disposed on the color resist layer and corresponding to the first via hole, and a third via hole disposed on the planarization protection layer and corresponding to the second via hole.

In an embodiment of the present application, the pixel electrode is electrically connected to the drain through the third via hole, the second via hole, and the first via hole in sequence.

In an embodiment of the present application, a side of the second transparent substrate adjacent to the first transparent substrate is provided with a black matrix, and the sealant is disposed between the passivation protective layer and the black matrix.

In an embodiment of the present application, the sealant has a width of 300 μm to 400 μm.

In an embodiment of the present application, the sealant has a height of 5 μm to 7 μm.

According to the above object of the present invention, a method of manufacturing a display panel is provided, comprising: providing a first transparent substrate and a second transparent substrate disposed opposite to each other, the display panel comprising a sealant area; forming a planarization protective layer between the first transparent substrate and the second transparent substrate, wherein the planarization protective layer is formed with a hollow portion in the sealant area; and forming a sealant between the first transparent substrate and the second transparent substrate in the sealant area, wherein the sealant extends into the hollow portion to cause the first transparent substrate and the second transparent substrate to be fixed through the sealant.

In an embodiment of the present application, before forming the planarization protection layer between the first transparent substrate and the second transparent substrate, the method further comprises: forming a TFT layer on the first transparent substrate, forming a passivation protective layer on the TFT layer, forming a first via hole on the passivation protective layer, and the planarization protection layer formed on a side of the passivation protection layer away from the TFT layer.

In an embodiment of the present application, forming of the sealant in the sealant area between the first transparent substrate and the second transparent substrate further comprises: forming a third via hole corresponding to the first via hole on the planarization protective layer, forming a conductive layer on the planarization protective layer, wherein the conductive layer is electrically connected to a drain of the TFT layer through the first via hole and the third via hole.

In an embodiment of the present application, before forming the planarization protection layer between the first transparent substrate and the second transparent substrate, the method further comprises: forming a color resist layer on the passivation protective layer and forming a second via hole corresponding to the first via hole on the color resist layer; wherein the planarization protective layer is formed on the color resist layer and the passivation protective layer and covers the color resist layer, and the conductive layer is electrically connected to the drain of the TFT layer through the first via hole, the second via hole, and the third via hole.

Beneficial effects of the present application are that: an embodiment of the present application removes a portion of the planarization protective layer located in the sealant area of the display panel in the existing structure. This reduces a thickness of an original planarized protective layer in a sealant coating region, thereby increasing a required seal spacing between the first transparent substrate and the second transparent substrate. This increases a coating pitch required for the sealant, thereby narrowing a width of the sealant and realizing the market demand for narrow frames. In addition, the manufacturing method of an embodiment of the present application is through a change in the structure of the planarization protective layer. Based on ensuring that an amount of sealant discharge and speed parameters are unchanged in an original sealant coating process, a narrow frame of the display panel is realized.

### DESCRIPTION OF DRAWINGS

In order to more clearly illustrate the technical solutions in the embodiments of the present application, the drawings used in the description of the embodiments will be briefly described below. It is obvious that the drawings in the following description are only some embodiments of the present application. Other drawings can also be obtained from those skilled in the art based on these drawings without paying any creative effort.

FIG. 1 is a schematic structural diagram of a display panel according to an embodiment of the present application.

FIG. 2 is a schematic block diagram of a method of manufacturing a display panel according to an embodiment of the present application.

FIG. 3 is a schematic block diagram of still another method of manufacturing a display panel according to an embodiment of the present disclosure.

### DETAILED DESCRIPTION OF PREFERRED EMBODIMENTS

The specific structural and functional details disclosed herein are merely representative and are for purposes of describing exemplary embodiments of the present application. The present application, however, may be embodied in many alternative forms and should not be construed as being limited to the embodiments set forth herein.

In the description of the present application, it is to be understood that a terminology or positional relationship of indications such as “center”, “lateral”, “upper”, “lower”, “left”, “right”, “vertical”, “horizontal”, “top”, “bottom”, “inside”, “outside”, etc. “bottom”, “inside”, “outside”, etc. is based on the orientation or positional relationship shown in the drawings. This is for ease of description of the application and a simplified description. This is not an indication or implied that the device or component referred to must have a particular orientation, is constructed and operated in a particular orientation, and thus is not to be construed as a limitation of the present invention. Moreover, the terms “first” and “second” are used for descriptive purposes only and are not to be construed as indicating or implying a relative importance or implicitly indicating the number of technical features indicated. Thus, features defining “first” and “second” may include one or more of the features either explicitly or implicitly. In the description of the present application, “a plurality” means two or more unless otherwise stated. In addition, the term “comprises” and its variations are intended to cover a non-exclusive inclusion.

In the description of the present application, it should be noted that the terms “installation”, “connected”, and “connected” are to be understood broadly unless otherwise specifically defined. For example, it may be a fixed connection, a detachable connection, or an integral connection. It can be a mechanical connection or an electrical connection. It can be directly connected or indirectly connected through an intermediate medium, which can be the internal connection between two components. The specific meanings of the above terms in the present application can be understood in the specific circumstances for those skilled in the art.

The terminology used herein is for the purpose of describing the particular embodiments, the singular forms “a”, “an”, It is also to be understood that the terms “comprises” and/or “includes”, as used herein, mean the presence of the stated features, integers, steps, operations, units and/or components. One or more other features, integers, steps, operations, units, components, and/or combinations thereof are not excluded.

The present application will be further described below in conjunction with the accompanying drawings and embodiments.

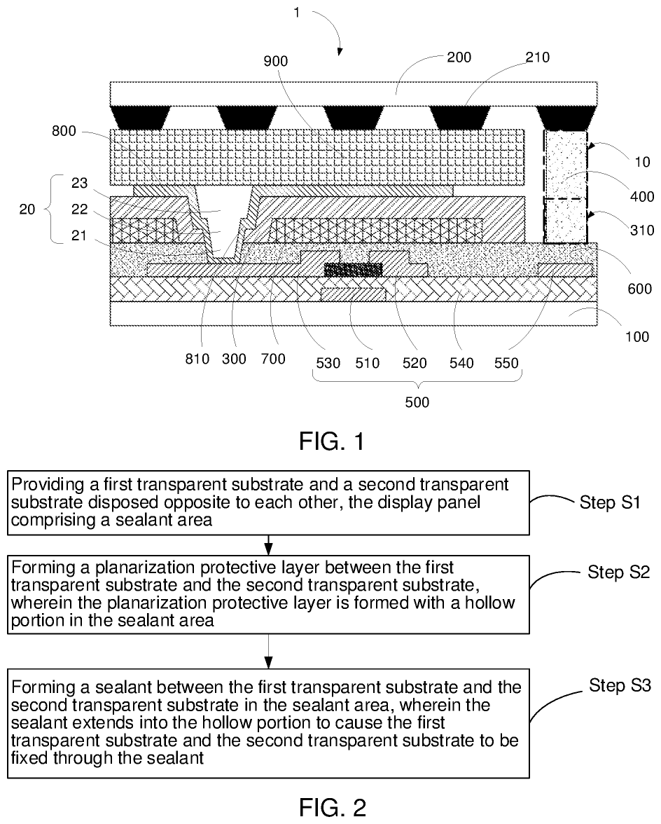

As shown in FIG. 1, an embodiment of the present application provides a display panel including a sealant area 10.

The display panel 1 includes a first transparent substrate 100 and a second transparent substrate 200 disposed opposite to each other. A planarization protection layer 300 is disposed between the first transparent substrate 100 and the second transparent substrate 200. The planarization protection layer 300 is formed with a hollow portion 310 in the sealant area 10. A sealant 400 located in the sealant area 10 is disposed between the first transparent substrate 100 and the second transparent substrate 200. The sealant 400 extends into the hollow portion 310 to fix the first transparent substrate 100 and the second transparent substrate 200 through the sealant 400.

It can be understood that a technical solution of the present application forms the hollow portion 310 by correspondingly hollowing out the planarized protective layer corresponding to a portion in the sealant area. This increases a required sealing distance between the first transparent substrate 100 and the second transparent substrate 200 to achieve narrowing of a width of the sealant 400. This approach is suitable for use in a variety of similar planarization protective layers that extend into the panel structure within the sealant area 10. Specifically, this embodiment uses a color filter on array (COA) type panel as an example for specific description.

The planarization protective layer 300 is formed with a hollow portion 310 in the sealant area 10. A sealant 400 located in the sealant area 10 is disposed between the first transparent substrate 100 and the second transparent substrate 200. The sealant 400 extends into the hollow portion 310. It can be understood that the planarization protection layer 300 is located in an inner area of the sealant 400 that is sealed and fixed. Specifically, the planarization protection layer 300 may have a certain distance from the sealant 400. Other structural forms in which the planarization protective layer 300 is formed with the hollow portion 310 in the sealant area 10 may also be used. Here, there is no limit.

In one embodiment, a TFT layer 500 is disposed on a side of the first transparent substrate 100 adjacent to the second transparent substrate 200. A passivation protective layer 600 is disposed on a side of the TFT layer 500 adjacent to the second transparent substrate 200. The planarization protection layer 300 is disposed on the passivation protection layer 600. The sealant 400 is disposed between the passivation protective layer 600 and the second transparent substrate 200.

Specifically, compared with the structure in which the sealant 400 of the original COA type panel is disposed on the planarization protective layer, in an embodiment of the present application, because the portion of the planarization protective layer 300 in the sealant area 10 is hollowed out, a height of the sealant 400 is increased. Based on ensuring that an amount of sealant discharge and speed parameters are unchanged in an original sealant coating process, a width of the sealant 400 is narrowed. This achieves a narrow frame of the display panel. Specifically, the sealant 400 has a width of 300 μm to 400 μm. A height of the sealant 400 ranges 5 μm to 7 μm. In addition, the TFT layer 500 includes a gate 510, a source 520, a drain 530, a gate protection layer 540, a metal trace layer 550, and the like. The specific structural forms are illustrated in FIG. 1 and are all prior art, and are not described herein again.

In an embodiment, the display panel 1 further includes a color resist layer 700, a conductive layer 800, and a liquid crystal layer 900 in an inner area of the sealant 400. The color resist layer 700 is disposed on the passivation protective layer 600. The planarization protection layer 300 is disposed on the color resist layer 700 and the passivation protection layer 600 and covers the color resist layer 700. The conductive layer 800 is disposed on the planarization protection layer 300. The liquid crystal layer 900 is disposed on the conductive layer 800.

In an embodiment, the conductive layer 800 includes a pixel electrode 810. A via hole 20 that sequentially passes through the passivation protective layer 600, the color resist layer 700, and the planarization protective layer 300 is disposed above the drain 530 of the TFT layer 500. The pixel electrode 810 is electrically connected to the drain 530 through the via hole 20.

In one embodiment, a black matrix 210 is disposed on a side of the second transparent substrate 200 adjacent to the first transparent substrate 100. The sealant 400 is disposed between the passivation protective layer 600 and the black matrix 210. Obviously, in the sealant structure of the plurality of panels, the combination of the sealant 400 and the black matrix 210 belongs to a conventional structure and will not be described in detail herein.

In summary, an embodiment of the present application removes a portion of the planarization protective layer located in the sealant area of the display panel in the existing structure. This reduces a thickness of an original planarized protective layer in a sealant coating region, thereby increasing a required seal spacing between the first transparent substrate and the second transparent substrate. This increases a coating pitch required for the sealant, thereby narrowing a width of the sealant and realizing the market demand for narrow frames.

According to the above object of the present invention, as shown in FIG. 2, a method of manufacturing a display panel is provided, comprising:

Step S1: providing a first transparent substrate 100 and a second transparent substrate 200 disposed opposite to each other, the display panel 1 comprising a sealant area 10.

Step S2, forming a planarization protective layer 300 between the first transparent substrate 100 and the second transparent substrate 200, wherein the planarization protective layer 300 is formed with a hollow portion 310 in the sealant area 10.

Step S3, forming a sealant 400 between the first transparent substrate 100 and the second transparent substrate 200 in the sealant area 10, wherein the sealant 400 extends into the hollow portion 310 to cause the first transparent substrate 100 and the second transparent substrate 200 to be fixed through the sealant 400.

In an embodiment of the present application, in details, before forming the planarization protection layer 300 between the first transparent substrate 100 and the second transparent substrate 200, the method further comprises:

Forming a TFT layer 500 on the first transparent substrate 100, forming a passivation protective layer 600 on the TFT layer 500, forming a first via hole 21 on the passivation protective layer 600, and the planarization protection layer 300 formed on a side of the passivation protection layer 600 away from the TFT layer 500.

Before forming the sealant 400 in the sealant area 10 between the first transparent substrate 100 and the second transparent substrate 200, the method further comprises:

Forming a third via hole 23 corresponding to the first via hole 21 on the planarization protective layer 300, forming a conductive layer 800 on the planarization protective layer 300, wherein the conductive layer 800 is electrically connected to a drain 530 of the TFT layer 500 through the first via hole 21 and the third via hole 23.

In an embodiment of the present application, in details, before forming the planarization protection layer 300 between the first transparent substrate 100 and the second transparent substrate 200, the method further comprises:

Forming a color resist layer 700 on the passivation protective layer 600 and forming a second via hole 22 corresponding to the first via hole 21 on the color resist layer 700; wherein the planarization protective layer 300 is formed on the color resist layer 700 and the passivation protective layer 600 and covers the color resist layer 700, and the conductive layer 800 is electrically connected to the drain 530 of the TFT layer 500 through the first via hole 21, the second via hole 22, and the third via hole 23.

It can be understood that formation of the third via hole 23 and the hollow portion 310 on the planarization protection layer 300 can be formed by the same patterning process. Specifically developed by exposure. In this process, an area of the portion of the planarization protection layer 300 that is removed near the sealant 400 may be made larger than an area of the hollow portion 310. In addition, manufacturing methods of other functional layers (such as coating, etching, or exposure and development processes) are all prior art, and will not be described herein.

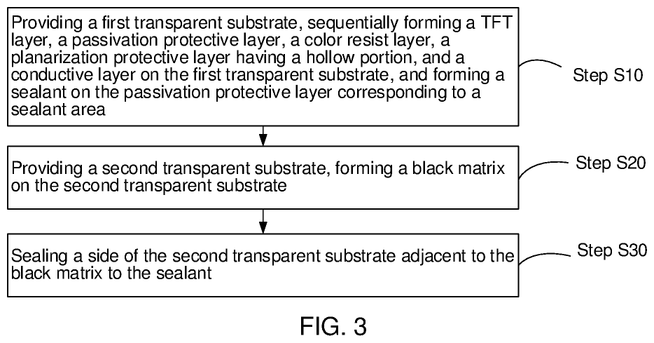

Based on the steps of the manufacturing method of the foregoing display panel, it can be understood that, as shown in FIG. 3, specifically, the method includes:

Step S10, providing a first transparent substrate 100, sequentially forming a TFT layer 500, a passivation protective layer 600, a color resist layer 700, a planarization protective layer 300 having a hollow portion 310, and a conductive layer 800 on the first transparent substrate 100, and forming a sealant 400 on the passivation protective layer 600 corresponding to a sealant area 10.

Step S20, providing a second transparent substrate 200, forming a black matrix 210 on the second transparent substrate 200.

Step S30, sealing a side of the second transparent substrate 200 adjacent to the black matrix 210 to the sealant 400.

In an embodiment, the via hole 20 is further formed by a patterning process after the passivation protective layer 600 is formed. The first via hole 21 is formed on the passivation protective layer 600 by sequentially applying a step of applying photoresist, developing, and etching. Then, after the color resist layer 700 is formed, specifically, it may be formed by exposure and development to form the second via hole 22 on the color resist layer 700. Finally, after the flat protective layer 300 is formed, the third via hole 23 may be formed on the planarization protective layer 300 by exposure and development. It is apparent that the first via hole 21, the second via hole 22, and the third via hole 23 constitute the via hole 20 in the foregoing structure. In addition, a conductive layer 800 is subsequently formed, and the conductive layer 800 is electrically connected to the drain 530 of the TFT layer 500 through the first via hole 21, the second via hole 22, and the third via hole 23. The steps and the like will not be described again.

It should be noted that, in the existing COA panel structure, a process of sequentially preparing a passivation protective layer, a color resist layer, a second via hole, a planarization protective layer, a third via hole, and finally a first via hole is sequentially prepared. When the first via hole is formed on the passivation protective layer at the end, etching can be performed using the planarization protective layer which is not used in a blank as a mask. In the embodiment of the present application, the planarization protective layer is hollowed out in the sealant area 10. According to the prior art process, in the process of forming the first via hole, a part of the passivation protective layer in the sealant area 10 is easily etched, and a metal trace layer 550 of the TFT layer 500 is exposed, resulting in a short circuit. Therefore, in the manufacturing method of the embodiment of the present application, after the passivation protective layer is formed, the first via hole 21 is directly formed on the passivation protective layer to avoid the occurrence of the mentioned conditions.

In summary, the manufacturing method of an embodiment of the present application is through a change in the structure of the planarization protective layer. Based on ensuring that an amount of sealant discharge and speed parameters are unchanged in an original sealant coating process, a narrow frame of the display panel is realized. Moreover, by adjusting the process, the issues that the metal trace layer is exposed due to the change of the structure of the planarization protective layer is avoided.

In the above, an embodiment of the present application removes a portion of the planarization protective layer located in the sealant area of the display panel in the existing structure. This reduces a thickness of an original planarized protective layer in a sealant coating region, thereby increasing a required seal spacing between the first transparent substrate and the second transparent substrate. This increases a coating pitch required for the sealant, thereby narrowing a width of the sealant and realizing the market demand for narrow frames. In addition, the manufacturing method of an embodiment of the present application is through a change in the structure of the planarization protective layer. Based on ensuring that an amount of sealant discharge and speed parameters are unchanged in an original sealant coating process, a narrow frame of the display panel is realized.

In summary, although the present application has been disclosed above in the preferred embodiments, the above preferred embodiments are not intended to limit the present application. Various modifications and refinements can be made by those skilled in the art without departing from the spirit and scope of the present application. The protection scope of the present application is therefore defined by the scope of the claims.

What is claimed is:

1. A display panel, comprising:
a sealant area;
a first transparent substrate and a second transparent substrate disposed opposite to each other;
a planarization protective layer disposed between the first transparent substrate and the second transparent substrate, wherein the planarization protective layer is provided with a hollow portion in the sealant area; and
a sealant disposed in the sealant area and disposed between the first transparent substrate and the second transparent substrate, wherein the sealant extends into the hollow portion to cause the first transparent substrate and the second transparent substrate to be fixed through the sealant.

2. The display panel according to claim 1, wherein a side of the first transparent substrate adjacent to the second transparent substrate is provided with a thin film transistor (TFT) layer, and a side of the TFT layer adjacent to the second transparent substrate is provided with a passivation protective layer, the planarization protective layer is disposed on the passivation protective layer, and the sealant is disposed between the passivation protective layer and the second transparent substrate.

3. The display panel according to claim 2, further comprising a color resist layer, a conductive layer, and a liquid crystal layer disposed in an inner area of the sealant, wherein the color resist layer is disposed on the passivation protective layer, the planarization protective layer is disposed on the color resist layer and the passivation protective layer and covers the color resist layer, the conductive layer is disposed on the planarization protective layer, and the liquid crystal layer is disposed on the conductive layer.

4. The display panel according to claim 3, wherein the conductive layer comprises a pixel electrode, a drain of the TFT layer is provided with a via hole sequentially passing through the passivation protective layer, the color resist layer, and the planarization protective layer, and the pixel electrode is electrically connected to the drain through the via hole.

5. The display panel according to claim 4, wherein the via hole comprises a first via hole disposed on the passivation protective layer, a second via hole disposed on the color resist layer and corresponding to the first via hole, and a third via hole disposed on the planarization protection layer and corresponding to the second via hole.

6. The display panel according to claim 5, wherein the pixel electrode is electrically connected to the drain through the third via hole, the second via hole, and the first via hole in sequence.

7. The display panel according to claim 2, wherein a side of the second transparent substrate adjacent to the first transparent substrate is provided with a black matrix, and the sealant is disposed between the passivation protective layer and the black matrix.

8. The display panel according to claim 1, wherein the sealant has a width of 300 μm to 400 μm.

9. The display panel according to claim 8, wherein the sealant has a height of 5 μm to 7 μm.

10. A method of manufacturing a display panel, comprising:
providing a first transparent substrate and a second transparent substrate disposed opposite to each other, the display panel comprising a sealant area;
forming a planarization protective layer between the first transparent substrate and the second transparent substrate, wherein the planarization protective layer is formed with a hollow portion in the sealant area; and
forming a sealant between the first transparent substrate and the second transparent substrate in the sealant area, wherein the sealant extends into the hollow portion to cause the first transparent substrate and the second transparent substrate to be fixed through the sealant.

11. The method of manufacturing the display panel according to claim 10, wherein before forming the planarization protection layer between the first transparent substrate and the second transparent substrate, the method further comprises:
forming a TFT layer on the first transparent substrate, forming a passivation protective layer on the TFT layer, forming a first via hole on the passivation protective layer, and the planarization protection layer formed on a side of the passivation protection layer away from the TFT layer.

12. The method of manufacturing the display panel according to claim 11, wherein forming of the sealant in the sealant area between the first transparent substrate and the second transparent substrate further comprises:
forming a third via hole corresponding to the first via hole on the planarization protective layer, forming a conductive layer on the planarization protective layer, wherein the conductive layer is electrically connected to a drain of the TFT layer through the first via hole and the third via hole.

13. The method of manufacturing the display panel according to claim 12, wherein before forming the planarization protection layer between the first transparent substrate and the second transparent substrate, the method further comprises:
forming a color resist layer on the passivation protective layer and forming a second via hole corresponding to the first via hole on the color resist layer; wherein the planarization protective layer is formed on the color resist layer and the passivation protective layer and covers the color resist layer, and the conductive layer is electrically connected to the drain of the TFT layer through the first via hole, the second via hole, and the third via hole.
